(19) United States
(12) Patent Application Publication
(10) Pub. No.: US 2008/0317155 A1
(43) Pub. Date: Dec. 25, 2008

(54) Power Control and Link Adaptation Scheme Based on Multi-User Detection

(75) Inventors: Georgios Orfanos, Aachen (DE); Jorg Habetha, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/910,626

(22) PCT Filed: Mar. 28, 2006
(86) PCT No.: PCT/IB2006/050940

§ 371 Date: Oct. 4, 2007

(30) Foreign Application Priority Data
Apr. 8, 2005 (EP) 05102786.0

(51) Int. Cl. H04B 7/005

(52) U.S. Cl. 375/267

(57) ABSTRACT

This invention provides a method for dynamically adjusting the transmitter power (P_{TX}) and data rate in a communications system. The scheme is specifically intended for wireless systems based on Code Division Multiple Access (CDMA) or on Multiple Input Multiple Output (MIMO) technology, but can be applied to all systems in which a so-called “Multi-User Detector” can be used. The method includes that the decision whether to increase or decrease the transmitter power (P_{TX}) is based on the Signal to Interference plus Noise Ratio (SINR) at the receiver (S2), whereby the receiver (S2) determines the interference (P_{IF}) with a Multi-User Detector. The interference level (P_{IF}) is then communicated to the sender (S1) or alternatively the receiver (S2) determines the optimal transmitter power level (P_{TX}) and communicates this level to the sender (S1). The proposed method reduces the power consumption and increases the performance e.g. in CDMA based systems.

The present invention is related to a method for signal processing according to a power control algorithm for Multi-Carrier Code Division Multiple Access (MC-CDMA) based Wireless Local Area Networks (W-LANs).

In code division multiple access (CDMA) networks the number of simultaneous transmissions can be increased until the Signal to Interference and Noise Ratio (SINR) at the receivers decreases to a limit that makes them unable to correctly receive and detect the intended packet. Therefore power control plays a major role for the system capacity.

MC-CDMA has gained recently significant attention and has become a promising candidate for future wireless high capacity communication networks. Multicarrier techniques are generally robust against multipath fading, provide high spectral efficiency and interference rejection capabilities. MC-CDMA has several other advantages, such as spectral diversity and immunity against frequency selective fading and impulse noise. Such system is exemplary described in the article of K. Wang, P. Zong, Y. Bar-Ness, “A reduced complexity partial sampling MMSE receiver for asynchronous MC-CDMA systems,” IEEE Proc. GLOBECOM'01, 2001, which is herewith incorporated by reference.

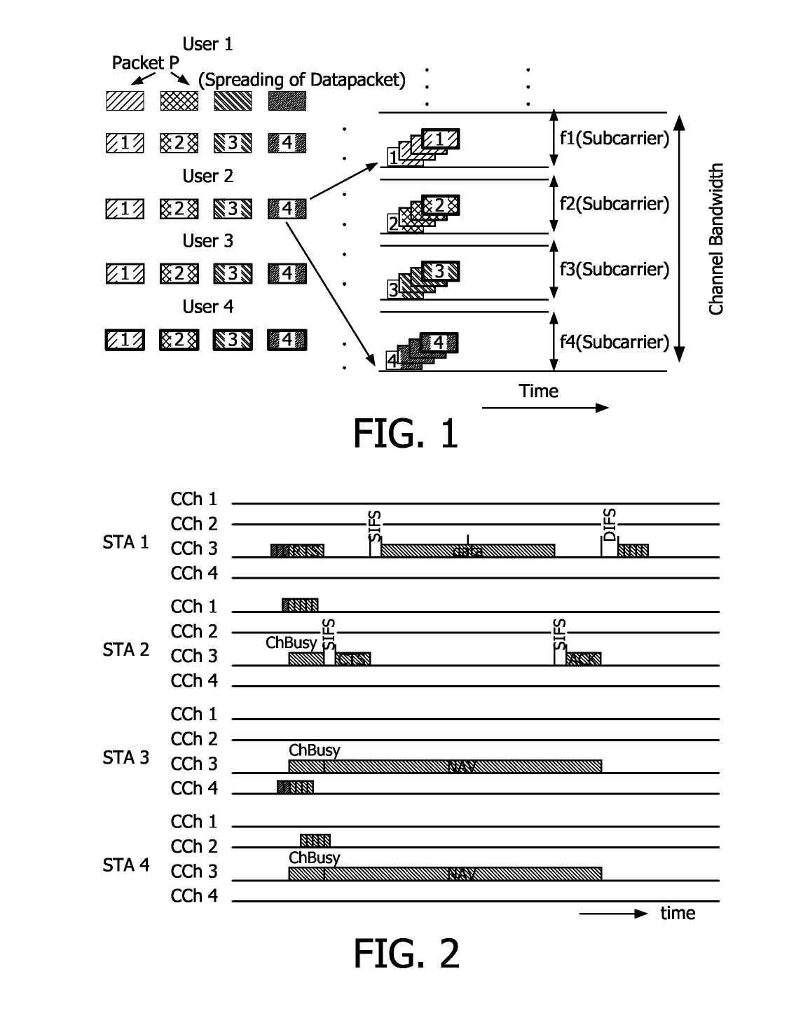

Each symbol of the data stream of one user is multiplied by each element of the same spreading code and is placed in several narrow band subcarriers. Multiple chips are not sequential, but transmitted in parallel on different subcarriers. This is described in detail in the article of J. Linnartz, “Performance analysis of synchronous MC-CDMA in mobile rayleigh channel with both delay and doppler spreads” IEEE Trans. On Vehicular Technology, vol. 50, issue 6, Nov. 2001, which is herewith incorporated by reference. In MC-CDMA one single data symbol is spread in frequency as described in the article of S. Hara, R. Prasad, “Overview of multicarrier CDMA,” IEEE Comm. Magazine, vol. 35, issue 4, pp. 104-108, April 1997, which is herewith incorporated by reference. Such a system with spreading factor (SF) four is presented in FIG. 1, which shows a MC-CDMA with an SF=4.

In FIG. 1 there are four 4 users. Each having a data packet. The data packet is spread with a spreading factor of 4. The result is shown on the right side of the FIG. 1. There are four chips. Each chip is modulated with a different subcarrier frequency f1, f2, f3, f4. These chips are formed into a multicarrier symbol which is transmitted via the channel. Since the chips only include a part of the original symbol, they could be packeted together with other chips based on symbols of other users. These chips of other users are simultaneously transmitted over the carrier frequency. In case of spreading with spreading factor 4 four chips may be multiplexed, since there are four spreading codes for differentiating the information at the receiver. The compound signal is received at the receiving side. There it is sampled and a Fast Fourier Transformation (FFT) is performed. For receiving information of e.g. user 3 a correlation needs to be performed at the receiving side to suppress the data of user 1, 2 and 4 and to receive the data of user 3. The correlation is performed in groups of four sampling values corresponding four chips, since the length of the spreading sequence is four.

A protocol for a possible implementation/embodiment of the invention is based on the Medium Access Control (MAC) protocol of the IEEE 802.11a WLAN, with some modifications needed to support the CDMA Physical Layer (PHY layer).

A station ready to transmit has to select a code-channel. For this selection two methods are possible. The first is to select a code-channel before every packet transmission. Initially this selection is done randomly. For later transmissions, the station does not select code-channels, which have already been reserved by other stations (according to the standard the considered station has set a Network Allocation Vector (NAV) for an occupied channel). The second method consists of selecting the code-channel with the least traffic and keeping this code-channel for the entire duration of the connection.

Before accessing the medium a station should detect the medium as idle for a duration called Distributed Inter-Frame Space (DIFS), and signals the intended data transfer by transmitting a RTS packet. A scheme of the RTS/CTS access mechanism is shown in FIG. 2. All stations STA3, STA4 that receive this RTS control packet, and are not the intended receivers, set their NAV timer, interrupt their backoff down counts, and defer from the medium in order not to interfere with the transmission. If the receiver STA 2 of the RTS is idle i.e. able to receive data, it responds with a CTS packet, after a time called Short Inter-Frame Space (SIFS). In case the receiver STA2 is busy the RTS transmission is repeated after a new backoff (not illustrated). Mobile stations which receive this CTS set their NAV timer as well. The sender STA1 can now transmit its data packet DATA after SIFS. The receiver STA2 acknowledges a successful reception by an Acknowledgement (ACK) also a SIFS time after the end of the data frame. The above standard Distributed Coordination Function (DCF) procedure is followed in every code-channel for each data transmission.

Multi-Carrier CDMA systems require like most asynchronous CDMA systems a so-called Multi-User Detector (MUD). The reason is that in asynchronous multi-access CDMA systems the received signal consists of the data of all active users. A timing mismatch destroys the orthogonality of the spreading codes of different users leading to multiple access interference (MAI), as described in the article of J. Linnartz, “Performance analysis of synchronous MC-CDMA in mobile rayleigh channel with both delay and doppler spreads” as mentioned above. For this reason a MUD has to be applied at the receiver side. An example of such a MUD is a linear detector based on the Minimum Mean Square Error (MMSE) criterion. A MMSE receiver combines both good performance and simplicity of implementation. A MMSE receiver or a MUD receiver, respectively, is illustrated in FIG. 3.

The receiving signal r(t) is sampled. Then the plurality of signals is demodulated. The last box represents the detector outputting an estimated symbol b(i). It is not illustrated but the MUD is further outputting the SNIR. As seen in the diagram of the receiver in FIG. 3, in a linear multi user detector the demodulator outputs yₘ are multiplied with a decision variable wₘ which is used for optimizing the decision of the detector on the transmitted symbol and mitigates the effects of the channel. In case of the MMSE MUD, the optimum weight matrix for a given set of delays τ_{K} and fading parameters βₖₘ is selected to minimize the mean square error of the detector:

MSE(τ,β)=E{(w^{H}y−bₖ)²} (1)

where bₖ is the k-th user's symbol.

A MUD is not only applied in many CDMA systems but also e.g. in MIMO systems. This is why the present invention also applies to the latter class of systems and all systems, which employ a MUD on the receiver side.

Many power control schemes are known from the literature. One could distinguish schemes with and without explicit feedback from the receiver. In a scheme without explicit feedback, the sender estimates the conditions at the receiver(s) and adjusts the power accordingly. In a scheme with explicit feedback, the receiver sends feedback on the receiving conditions or a recommended power level to the sender. The present invention is a power control scheme with explicit feedback. Another example of an explicit feedback scheme is described in as exemplary described in the article of D. Qiao, S. Choi, A. Jain, K. Shin, “Adaptive Transmit Power Control in IEEE 802.11a Wireless LANs,” in Proc. IEEE VTC 2003-Spring, April 2003, which is herewith incorporated by reference. Therein the feedback is sent in the CTS of the receiver. This approach can also be used to implement the scheme of the present invention.

The object of the present invention is to overcome problems or disadvantages as mentioned above, and to provide a method, a sender and a receiver saving power and increasing the system performance.

The object is solved by the features of the independent claims.

According to the present invention a new power control algorithm for Multi-Carrier Code Division Multiple Access (MC-CDMA) based Wireless Local Area Networks (W-LANs) is proposed. The algorithm makes use of the Minimum Mean Square Error (MMSE) Multi-User Detector (MUD) properties in order to rapidly adjust the transmission power of the Mobile Stations (MSs). The enhancement achieved by the application of the proposed algorithm to a MC-CDMA based W-LAN is demonstrated by means of simulation. The results are shown below in the chapter “Performance evaluation of invented algorithm by simulations” forming the last part of the description.

The essential features of the invention are the determination of the interference level and thereby the SINR by means of the MUD and the use of this value to determine the appropriate Tx power.

In an embodiment the receiver gives feedback to the sender by means of a CTS (or similar handshake) frame. Two alternative embodiments are possible: Either the sender includes the SINR value in the feedback frame or it derives an optimal Tx power level from the SINR value and includes the recommended Tx power in the feedback frame (rsp. an indication to increase or decrease the Tx power).

This invention provides a method for dynamically adjusting the transmitter power and/or the data rate in a communications system. The scheme is specifically intended for wireless systems based on Code Division Multiple Access (CDMA) or on Multiple Input Multiple Output (MIMO) technology, but can be applied to all systems in which a so-called “Multi-User Detector” can be used. The scheme foresees that the decision whether to increase or decrease the transmitter power is based on the Signal to Interference plus Noise Ratio (SINR) at the receiver, whereby the receiver determines the interference with a Multi-User Detector. The interference level is then communicated to the sender or alternatively the receiver determines the optimal transmitter power level and communicates this level to the sender.

The proposed scheme cannot only reduce the power consumption but is also crucial for a good performance e.g. in CDMA based systems.

As most power control schemes, the present invention allows to dynamically adjust the transmitter (Tx) power for the purpose of saving power and increasing the system performance by mitigating varying channel conditions and transmissions of neighboring stations, the near-far-effect in CDMA systems, etc.

More specifically, the invention overcomes the problem that the Signal to Interference plus Noise Ratio (SINR) is the most appropriate criterion for selecting the Tx power level but that the interference (I) is not known at the sender side and difficult to determine on the receiver side.

Furthermore, the invention enables a very fast feedback from the receiver to the sender to enable fast adaptation to varying conditions.

In the simplest embodiment the receiver is only calculating the interference level in the MUD, which is fed back to the sender. The sender knows its current transmit power and can calculate the transmitting power to be used based on the fed back interference level.

In case of calculating the SINR or a recommended transmitting power in the receiver the sender needs to transmit its current transmit power. Based on the current transmit power the SINR or the recommended transmit power is calculated and fed back to the sender.

It is further possible that the current transmit power is defined in advance. Thus the sender has not to transmit its current transmit power to the receiver. The receiver can use the previously defined transmit power for calculating the SINR or the recommended transmit power.

FIG. 1 shows a Multicarrier Code Division Multiple Access system having a spreading factor SF=4, according to the prior art;

FIG. 2 illustrates a RTS/CTS access mechanism according to IEEE 802.11a WLAN;

FIG. 3 illustrates a receiver including a MUD based on minimum mean square error MMSE;

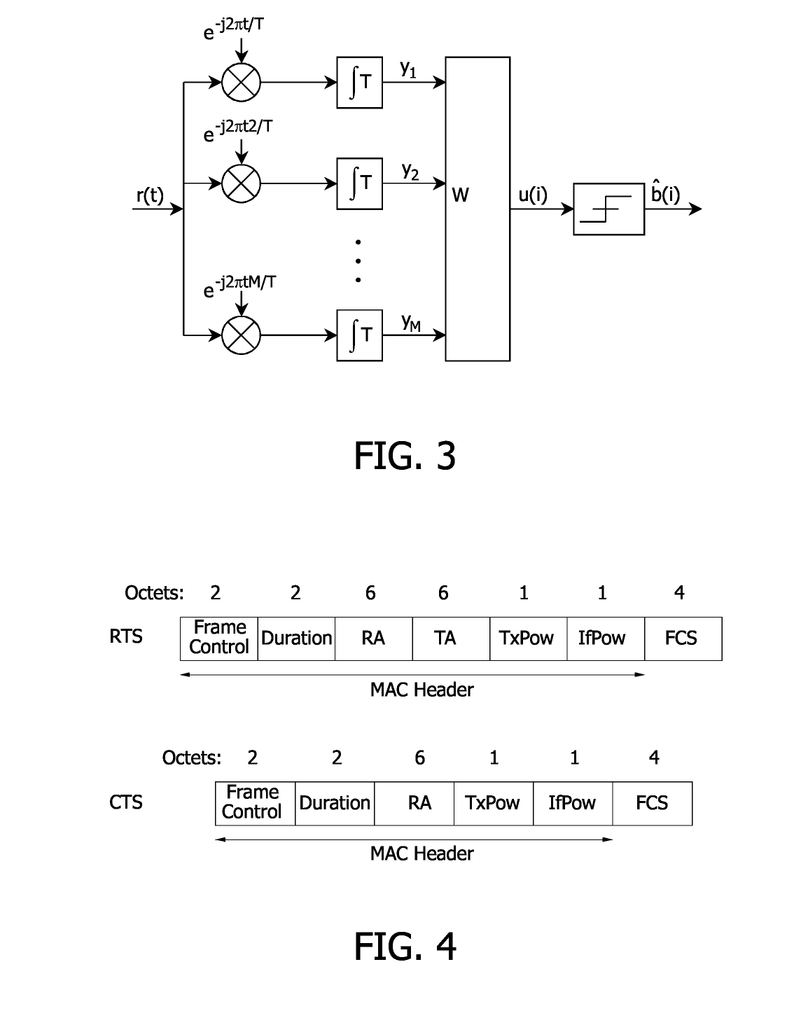

FIG. 4 illustrates a configuration of RTS/CTS frames according to the present invention;

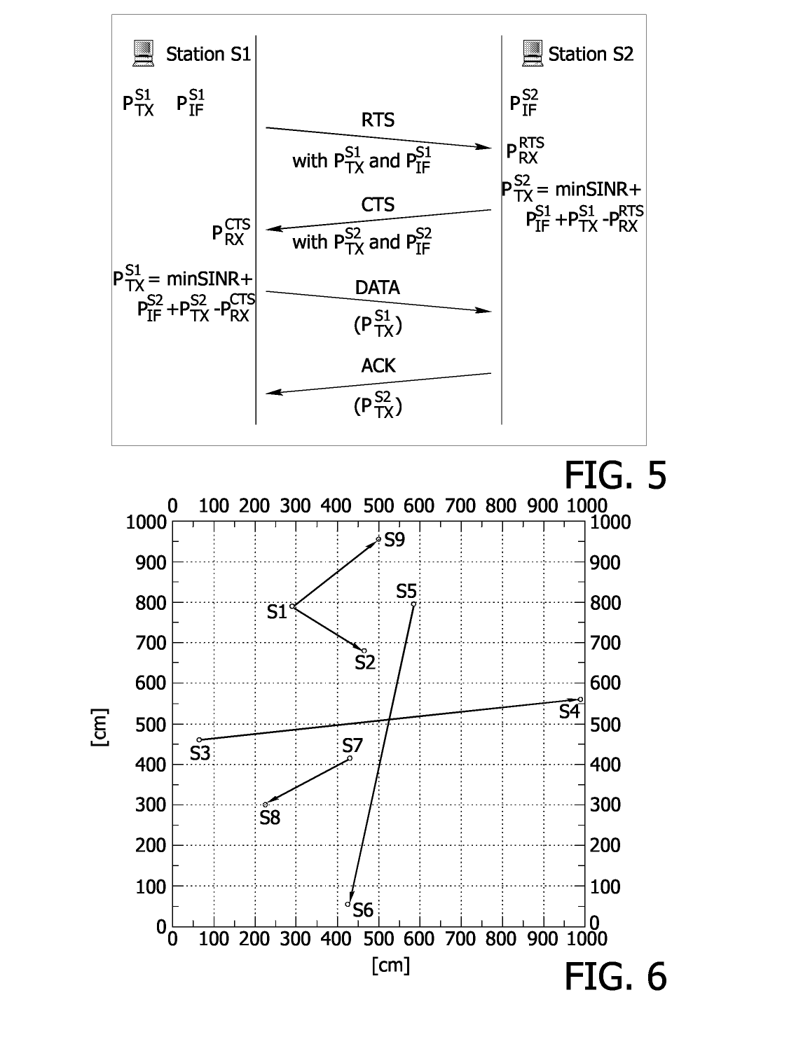

FIG. 5 shows a flow chart illustrating the signal flow between a first and a second station according to an embodiment of the present invention;

FIG. 6 presents a plurality of wireless communicating stations;

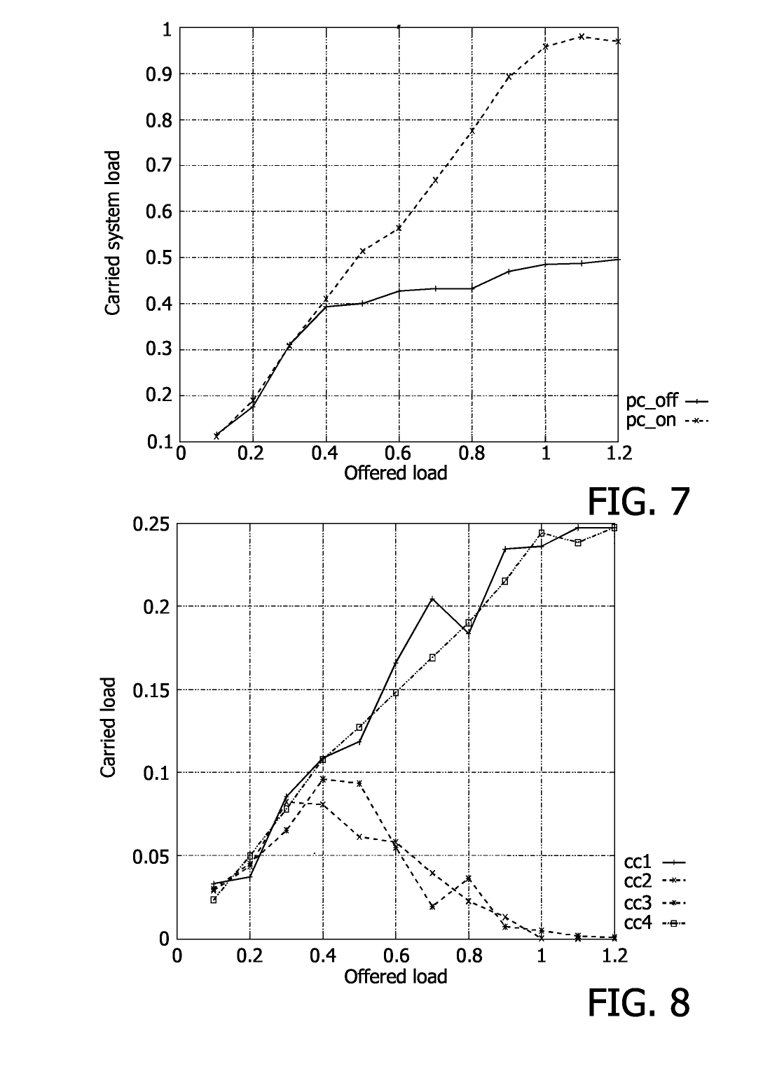

FIG. 7 shows a diagram illustrating the carried system load vs. the offered load with and without power control according to the present invention;

FIG. 8 illustrates carried load per channel without inventive power control;

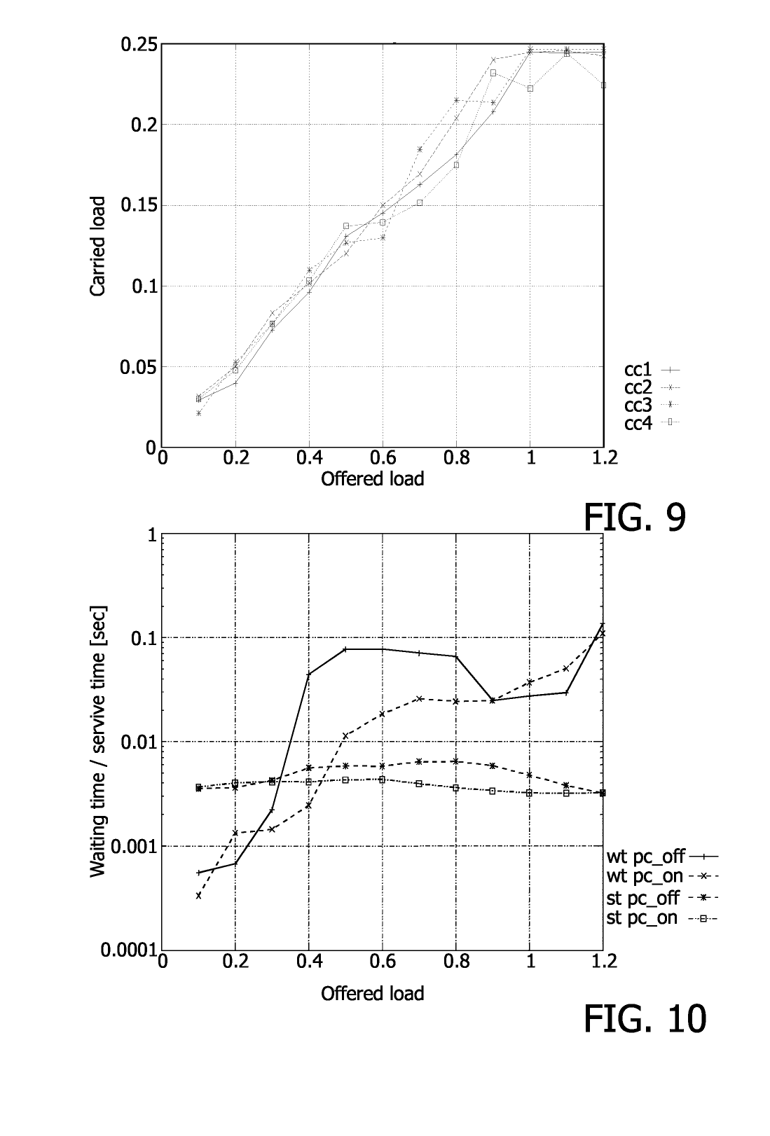

FIG. 9 illustrates throughput per code-channel without the inventive power control;

FIG. 10 illustrating the mean waiting times and service times with and without the inventive power control;

The interference is determined according to the mean interference during the reception of previously receives frames, P_{MeanIF}. The value of P_{MeanIF} is calculated in each station separately, as given in (2).

$${P}_{MeanIF} = \{ \begin{matrix}{P}_{LastIF} , & {P}_{MeanIF} = 0 \\ 0 , 75 {P}_{MeanIF} , & else\end{matrix} \qquad ( 2 )$$

The interference during the last received frame is weighted with 25% since this is the most recent value.

A station can calculate the value of the mean interference, during the reception of one frame, from the estimate of the mean SINR of that frame. The latter can be calculated with the help of the MUD.

The received signal can be described by the following equation:

$$r ( t ) = {\sum }_{k = 1}^{K} \sqrt{{a}_{k}} {b}_{k} {\sum }_{m = 1}^{M} {c}_{k m} {h}_{k m} {e}^{j 2 π ( t - {τ}_{k} ) m / T} p ( t - {τ}_{k} ) + η ( t ) \qquad ( 3 )$$

where K is the maximum number of active users, aₖ the transmission power of the k-th user's symbol bₖ, M the number of subcarriers, p(t) a rectangular pulse over [0,T], τₖ the delay of the k-th user and η(t) denotes the additive white Gaussian noise. The Rayleigh fading process for the m-th subcarrier and k-th user is represented as:

hₖₘ=βₖₘe^{jφkm} (4)

with βₖₘ a Rayleigh distributed and φₖₘ a uniform over [0,2π) distributed variable.

In this case the SINR can be given from the following expression:

$$S I N R = \frac{{\vert \sqrt{{a}_{1}} {w}^{H} {p}_{K + 1} \vert}^{2}}{{w}^{H} Γ w + {\vert {w}^{H} {P}_{K + 1} {A}_{K + 1} \vert}^{2}} \qquad ( 5 )$$

where the matrices P and p are obtained from (3) as derived in the articles of K. Wang, P. Zong, Y. Bar-Ness, “A reduced complexity partial sampling MMSE receiver for asynchronous MC-CDMA systems”, as mentioned above or from S. Yi, C. Tsimenidis, O. Hinton, B. Sharif, “Adaptive minimum bit error rate multi-user detection for asynchronous MC-CDMA systems in frequency selective rayleigh fading channels,” IEEE Proc. PIMRC 2003, Sep. 7-10, 2003, which is herewith incorporated by reference. Further, w is the weight vector of the MUD. F is the covariance matrix of the Gaussian noise vector. It is obvious from Eq. (5) and the analysis in the articles, that a station, which uses four correlators is able to calculate an estimate of the SINR according to Eq. (5).

After estimating the SINR, the station can estimate the mean interference during the packet reception for a known reception power.

As mentioned before in a possible embodiment of the invention, the RTS-CTS (or a similar handshake mechanism) is used for transmitting the interference/SINR from the receiver to the sender.

For this purpose RTS and CTS frames (or similar handshake frames) are extended with two more fields, TxPow and IfPow respectively, as depicted in FIG. 4, which shows extended RTS and CTS frames. In the field TxPow of the RTS the transmit power of the current frame is encoded and If Pow in the CTS carries information regarding the last estimate of the mean interference or SINR for this station at the channel on which the data transfer takes place. The length of each field consists of one byte.

Station S1 denotes the transmitter and station S2 the corresponding receiver. Further variables needed for the algorithm are defined in the following Table 1 showing Power Control Parameters. All values are given in dBm.

TABLE 1

| Parameter | Value |
|---|---|
| P_{TX}^{S1} | Tx-Power of station S1 |
| P_{TX}^{S2} | Tx-Power of station S2 |
| P_{IF}^{S1} | Mean interference estimate of S1 |
| | before the transmission of the RTS |
| P_{IF}^{S2} | Mean interference estimate of S1 |
| | before the transmission of the CTS |
| P_{RX}^{RTS} | Rx-Power of the RTS frame in S2 |
| P_{RX}^{CTS} | Rx-Power of the CTS frame in S1 |

Additionally each station uses a fixed threshold minSINR (set in dB), giving the minimum needed value of SINR, for the reception of the packets at a given transmission rate. The value of this threshold is chosen, depending on the used PHY layer mode (PHY mode), for the Packet Error Rate (PER) to be equal to a certain value (e.g. 1%).

FIG. 5 provides an overview of the power control algorithm. Station S1 transmits an RTS frame, using the extended frame format of FIG. 4. In the frame the current values of P_{TX}^{S1} and P_{IF}^{S1} are set. Station S2 receives the RTS frame with power P_{RX}^{RTS} and decodes the values of P_{TX}^{S1} and P_{IF}^{S1}. S2 can now calculate the pathloss L between S1 and S2:

L=P_{TX}^{S1}−P_{RX}^{RTS} (6)

Afterwards, S2 calculates the minimum needed receive power for S1 under consideration of the actual mean interference estimate P_{IF}^{S1} and the chosen threshold minSINR:

min P_{RX}^{S1}=min SINR+P_{IF}^{S1} (7)

From (6) and (7) the minimum needed Tx-Power for S2 can be calculated:

P_{TX}^{S2}=min P_{RX}^{S1}+L (8)

This Tx-Power is saved in S2 and used for coming transmissions to S1.

FIG. 5 shows a scheme for describing the power control algorithm.

S1 receives the CTS frame with Rx-Power P_{RX}^{CTS} and decodes from the frame the values of P_{TX}^{S2} and P_{IF}^{S2}. Accordingly S1 calculates the pathloss between S1 and S2:

L=P_{TX}^{S2}−P_{RX}^{CTS} (9)

and the minimum needed Rx-Power for S2:

min P_{RX}^{S2}=min SINR+P_{IF}^{S2} (10)

From (9), (10), the Tx-Power for S1 can be calculated:

P_{TX}^{S2}=min P_{RX}^{S1}+L (11)

The calculated Tx-Power is saved in S1 and used for forthcoming transmissions to S2.

After receiving the data packet, S2 transmits the ACK with the Tx-Power calculated before.

It is possible though that S2 cannot receive correctly either the RTS or the data packet (no CTS or ACK arrives in S1) due to high interference. In this case, S1 repeats the transmission with double Tx-Power:

P_{TX}^{S1}=P_{TX}^{S1}+3 dBm (12)

The successful reception of a frame is followed by an update of P_{MeanIF}.

As mentioned before, alternative embodiments can be specified in the final application, wherein the RTS and CTS fields are defined differently and include e.g. a recommended Tx power level P_{TX}(S1) or P_{TX}(S2) respectively.

In the following the performance evaluation of the invented algorithm will be explained by means of simulations.

For the performance evaluation of the invented power control scheme, event-driven simulations are used to measure the throughput that is practically achievable. For the evaluation of the packet delay, the Least Relative Error (LRE) algorithm is used with a maximum relative error of 2%. Such Least Relative Error (LRE) algorithm is described in F. Schreiber, “Effective Control of Simulation Runs by a New EvaluationAlgorithm for Correlated Random Sequences,” in AEÜ International Journal of Electronics and Communications, vol. 42, no. 6, pp. 347-354, 1988, which is herewith incorporated by reference. Further parameters of the simulation setup are given in the following Table 2.

TABLE 2
Simulation Parameters

| Parameter | Value | |
|---|---|---|
| Max. TxPower | 17 | dBm |
| Spreading Factor | 4 | |
| Cwmin | 4 | slots |
| Cwmax | 255 | slots |
| Number of Subcarriers | 48 Data + 4 Pilot | |
| Subcarrier Spacing | 0.3125 | MHz |
| Channel Bandwidth | 20 | MHz |
| Carrier Frequency | 5.25 | GHz |
| Noise Level | −93 | dBm |
| Path loss Factor | 3.5 | |
| TxRate Data | 12 | Mbps |
| TxRate Control | 12 | Mbps |
| RTS/CTS | enabled | |
| Symbol Interval | 4 μs = 3.2μ + 0.8 μs | |
| Guard Interval | 0.8 | μs |
| Preamble | 16 | μs |
| Max. Propagation | 0.15 | μs |
| Delay | | |
| PDU Length | 1024 | Byte |

FIG. 6 shows the simulated scenario consisting of 9 terminals establishing 5 links in a 10 m×10 m area, addressing Small Office-Home Office (SOHO) scenarios; the content of FIG. 6 such can also be named as “SOHO simulation scenario”. Simulations are performed using the QPSK ½ PHY mode for both data and control packets.

Connections from station 1 (S1) to S2 and S1 to S9 take place in code-channel (cch) 1, the connection from S3 to S4 in cch 2, connection from S5 to S6 in cch 3 and connection from S7 to S8 takes place in cch 4. The minSNR value is set to 12 dB. For this PHY-mode and the used packet length a value of 9.5 dBm is sufficient for the PER to be almost zero. The 2.5 dB margin is added in order to mitigate the effects of short term fading.

In FIG. 7 the carried system load vs. the offered load is given for the cases of both activated and deactivated power control. This is also called the system throughput. The offered load is a percentage of the channel capacity, which is for QPSK ½ 12 Mbit/s. The system performance with Power Control is almost 100% better than without. In this case the maximum achieved throughput is 9.8 Mbit/s, which corresponds to 96% of the theoretical maximum as described in the article of G. Orfanos, J. Habetha, L Liu, “MC-CDMA based IEEE 802.11 wireless LAN,” Proc. IEEE MASCOTS 2004, October 2004, which is herewith incorporated by reference. The throughput loss when Power Control is deactivated is a result of the near-far-effect. This effect occurs when an interferer is closer to a receiving station than its corresponding transmitter. Accordingly the receiver cannot detect the intended signal out of the received one and the data transmission fails.

This effect as well as the contribution of Power Control to its solution can be even better depicted from the following figures. FIG. 8 gives the carried load per code-channel, i.e. the throughput per code-channel, without Power Control. All stations use the maximum transmit power of 50 m Watt (17 dBm). In this case, the long distanced transmissions, S3→S4 and S5→S6, suffer from high interference. Even with the robust PHY-mode of QPSK ½ no data packet can be carried by these connections. At the same time, short distance connections run without problems and as can be seen from the diagram, the corresponding code-channels (cch1 and cch4) achieve almost the maximum throughput (each a quarter of the channel throughput).

FIG. 9 shows the throughput per code-channel with power control, i.e. the carried load per code-channel with the offered load for the case that Power Control is activated. The output powers of the transmitting stations are now adjusted by the Power Control algorithm to the following:

| | |
|---|---|
| S1 | −32.0 dBm |
| S3 | −25.3 dBm |
| S5 | −27.4 dBm |
| S7 | −33.4 dBm |

It can be seen from FIG. 9 that after these power arrangements no connection is blocked and the system achieves a high throughput in every code-channel.

In FIG. 10 showing delay measurements the mean (over all successfully received packets) waiting and service time is shown as a function of the offered load. When Power Control is activated the service time is almost constant whereas the waiting time increases with the load as expected. When Power Control is turned off, the service time is not affected and remains constant since no collisions occur. It must be noticed that when the offered load increases to 0.4 or more, this service time refers to 3 of the 5 connections. The packet transfer for the others has been blocked due to the near-far effects.

The graph for the mean waiting time without Power Control is very interesting for the system analysis. The waiting time delay increases rapidly for an offered load between 0.2 and 0.5, as the two long distanced connections have a decreasing chance to transmit a packet. Successful transmissions for these connections occur after some retries with a higher Contention Window (CW), when the other two connections are not active due to small load. The fall of the waiting time curve for 0.9 offered load is due to the blocked long distanced connections, which from now on do not contribute to the waiting time measurements, as no more frames are successfully transmitted by them.

Thus the present invention provides a method to dynamically adjust the transmitter (Tx) power for the purpose of saving power and increasing the system performance by mitigating varying channel conditions and transmissions of neighboring stations, the near-far-effect in CDMA systems, etc.

Thereby it is possible to solve the problem that the Signal to Interference plus Noise Ratio (SINR) is the most appropriate criterion for selecting the Tx power level but that the interference (I) is not known at the sender side and difficult to determine on the receiver side.

The invention enables a very fast feedback from the receiver to the sender to enable fast adaptation to varying conditions.

1. A method of dynamically selecting the transmit power (P_{TX}) and/or data rate in a communications network including a plurality of devices (STA1-STA9), comprising the steps of:
the receiver (S2) of a data stream of data packets calculates the mean interference level (P_{IF}) of at least a single previous data packet by means of a Multi-User Detector; and
the receiver (S2) transmitting feedback to said sender (S1) regarding the interference level (P_{IF}) and/or Signal to Interference and Noise Ratio (SINR) and/or recommended transmit power and/or data rate or a combination thereof; and
the sender (S1) choosing the transmit power (P_{TX}) and/or data rate considering the feedback from the one or several receivers (S2) of the data stream.

2. A method of claim 1, wherein the sender (S1) of the data stream indicates its current transmit power (P_{TX}) to the receiver (S2) for calculating Signal to Interference and Noise Ratio (SINR) and/or recommended transmit power in the receiver, which is fed back to the sender (S1).

3. A method of claim 1, wherein:
said sender (S2) includes its current transmit power (P_{TX}) in a signalling packet prior to a data frame and/or in the data frame itself.

4. A method as claimed in claim 3, wherein: said signalling packet is a Ready-to-Send (RTS) packet according to the standard IEEE 802.11 or an equivalent packet according to later revisions of the standard (802.11n).

5. A method as claimed in claim 1, wherein:
said receiver (S2) includes said feedback in a signalling packet prior to a data frame and/or in an own data frame on the return link.

6. A method as claimed in claim 5, wherein:
said signalling packet is a Clear-to-Send (CTS) packet according to the standard IEEE 802.11 or an equivalent packet according to later revisions of the standard (802.11n).

7. A method as claimed in claim 1, wherein:
said mean interference (P_{IF}) is calculated as sliding average of the interference derived from the Multi-User Detector during the last transmitted frame of the sender and the previously calculated mean interference level.

8. A method as claimed in claim 1, wherein:
said communications network is using Multi-Carrier CDMA technology.

9. A method as claimed in claim 1, wherein:
said communications network is using Multiple Input Multiple Output (MIMO) antenna technology.

10. A sender in a communications network including a plurality of devices (STA1-STA9) for sending a data stream including:
means for sending a data stream to a receiver (S2); and
means for receiving a feedback sent out from the receiver (S2) including information regarding the interference level (P_{IF}) and/or Signal to Interference and Noise Ratio (SINR) and/or recommended transmit power and/or data rate; which is calculated in the receiver (S2) by use of Multi User Detector;
the sender (STA1) choosing the transmit power (P_{TX}) and/or data rate considering the feedback from the one or several receivers (STA2) of the data stream.

11. A receiver (S2) of a data stream for performing a dynamically selecting of a transmit power (P_{TX}) and/or data rate in a communications network including a plurality of devices (STA1-STA9) including:
means for receiving a data stream from a sender (S1); and
means for calculating the mean interference level (P_{IF}) of at least a single previous data packet by means of a Multi-User Detector; and
means for transmitting feedback to said sender (S1) regarding the interference level (P_{IF}) and/or Signal to Interference and Noise Ratio (SINR) and/or recommended transmit power and/or data rate for selecting the transmit power (P_{TX}) and/or data rate considering the feedback from the one or several receivers (S2) of the data stream.

12. A communications network including a plurality of devices (STA1-STA9), comprising at least one sender (S1) and one receiver (S2) of a data stream for performing a method as claimed in claim 1.
